(19) United States
(12) Patent Application Publication
(10) Pub. No.: US 2012/0316923 A1
(43) Pub. Date: Dec. 13, 2012

(54) METHOD, APPARATUS, AND COMPUTER-READABLE MEDIUM FOR THE DETERMINATION OF LEVELS OF INFLUENCE OF A GROUP

(75) Inventors: Keyvan Rafei, (US); Alex Taranenko, (US); Saleh Al-Ghafari, (US); Derar Ali, (US); Jennifer Lopatin, (US)

(73) Assignee: GEOGRAPHIC SERVICES, INC., MCLEAN, VA (US)

(21) Appl. No.: 13/493,390

(22) Filed: Jun. 11, 2012

Related U.S. Application Data
(60) Provisional application No. 61/495,693, filed on Jun. 10, 2011.

(51) Int. Cl. G06Q 30/02

(52) U.S. Cl. 705/7.34; 705/7.29; 705/7.33

(57) ABSTRACT

A level of influence score is determined for at least one member of a group of persons based on biographical data corresponding to the at least one member of the group of persons. The level of influence scores for the group are aggregated to determine aggregate level of influence score. The aggregate level of influence score can be used to determine a composite level of influence for the group of persons. An influenced-group parameter may be utilized in conjunction with the biographical data corresponding to the at least one member of the group of persons to determine the level of influence score. A spatial scale parameter may also be utilized in conjunction with the biographical data corresponding to the at least one member of the group of persons to determine the level of influence score.

### RELATED APPLICATION DATA

This application claims priority to U.S. Provisional Application No. 61/495,693, filed Jun. 10, 2011, the disclosure of which is hereby incorporated in its entirety.

### FIELD OF THE INVENTION

The invention relates to a system and method for determining the level of influence of a group of persons.

### BACKGROUND

Conducting operations such as construction projects, business operations, political events, military operations, humanitarian aid, or other activities in a foreign country can be a complicated endeavor. In many situations, there are no clear cut rules concerning how to operate or who to obtain authorization from, and a failure to recognize and communicate with those who wield influence can lead to disastrous consequences. As a result, the proper procedure for conducting operations in a particular country is not always clear, and can vary from region to region.

### SUMMARY

A method, apparatus, and computer readable medium are disclosed which allow users unfamiliar with a geopolitical landscape to quickly understand and quantify the levels of influence wielded by groups of people in a particular geographic area.

A level of influence (“LOI”) score can be determined for at least one member of a group of persons, for example, based on biographical data corresponding to the at least one member of the group of persons. The LOI scores for the group can be aggregated to determine an aggregate LOI score. The aggregate LOI score can be used to determine a composite LOI for the group of persons.

Exemplary biographical data can include occupation, occupational history, government affiliations, military affiliations, wealth, tribal affiliations, familial affiliations, education, religious convictions, religious affiliations, professional affiliations, military rank, police rank, political views, political affiliations, or other biographical data.

The LOI score for the at least one member of the group of persons can comprise a numerical value representative of the influence an individual with the corresponding biographical data exerts in a geographic arena.

An influenced-group parameter may be utilized in conjunction with the biographical data corresponding to the at least one member of the group of persons to determine the LOI score. In some embodiments, the influenced group parameter can comprise a family, a clan, or a tribe.

When an influenced-group parameter is utilized, the LOI score can be a numerical value representative of the influence an individual with the corresponding biographical data exerts on groups corresponding to the influenced-group parameter in a geographic arena.

A spatial scale parameter may be utilized in conjunction with the biographical data corresponding to the at least one member of the group of persons to determine the LOI score. In some embodiments, the spatial scale parameter can comprise a local scale, a provincial scale, or a national scale.

When a spatial scale parameter is utilized, the LOI score can be, for example, a numerical value representative of the influence an individual with the corresponding biographical data exerts in a geographic arena corresponding to the spatial scale parameter.

In some embodiments, the composite LOI for the group can be determined by comparing the aggregate LOI score with a plurality of score thresholds corresponding to a plurality of influence categories. If the aggregate LOI score is greater than or equal to at least one score threshold, for example, the composite LOI of the group can be set to be the influence category corresponding to the highest score threshold that the aggregate LOI score is greater than or equal to. Otherwise the composite LOI of the group can be set to a default value.

### BRIEF DESCRIPTION OF THE DRAWINGS

FIG. 1 is a flowchart of an exemplary method of determining the aggregate LOI score of a group of people according to the disclosed embodiment.

FIG. 2 is an exemplary flowchart demonstrating how the aggregate LOI score can be used to determine the composite LOI of a group of people in the form of an influence category according to the disclosed embodiment.

FIG. 3 is an exemplary flowchart demonstrating the determination of a person's LOI score utilizing biographical data according to the disclosed embodiment.

FIG. 4 is an exemplary flowchart demonstrating the determination of a person's LOI score and taking into account the group that is being influenced according to the disclosed embodiment.

FIG. 5 is an exemplary flowchart demonstrating the determination of a person's LOI score and taking into account the geographic area over which influence is being determined according to the disclosed embodiment.

FIG. 6 is an exemplary flowchart demonstrating the determination of a person's LOI score and taking into account the group that is being influenced and the geographic area over which influence is being determined according to the disclosed embodiment.

FIG. 7 shows an exemplary computing environment useful for implementing apparatuses and computer readable media, and performing methods according to the disclosed embodiment.

### DETAILED DESCRIPTION

While methods, apparatuses, and computer-readable mediums are described herein by way of examples and embodiments, those skilled in the art recognize that methods, apparatuses, and computer-readable mediums for determining the LOI of a group are not limited to the embodiments or drawings described. It should be understood that the drawings and description are not intended to be limited to the particular form disclosed. Rather, the intention is to cover all modifications, equivalents and alternatives falling within the spirit and scope of the disclosed embodiments. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

I. Determining the Aggregate LOI Score for a Group

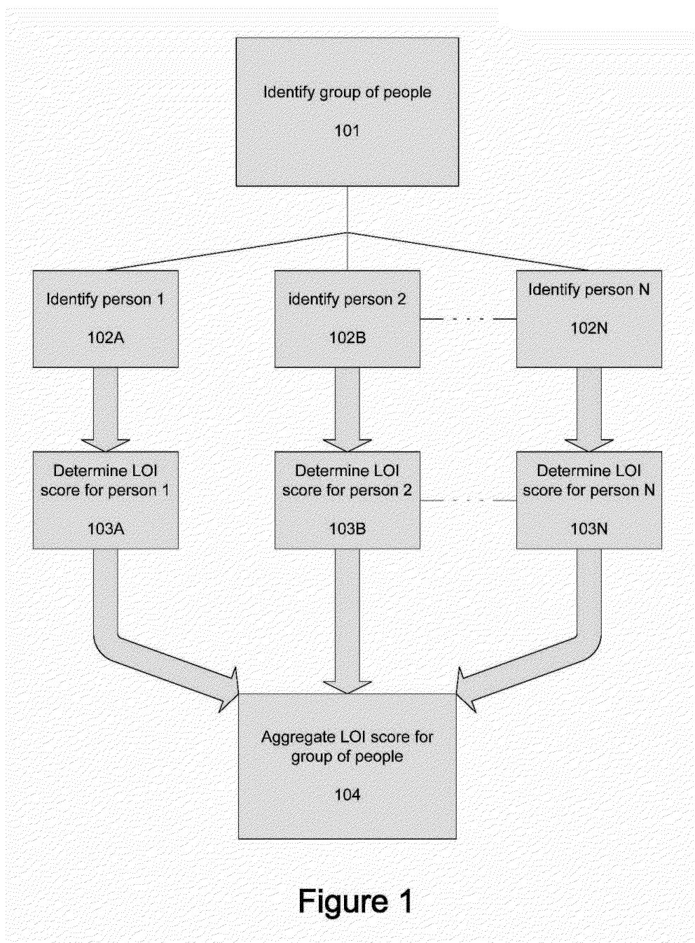

FIG. 1 presents a flowchart with an overview of an exemplary process used to determine the aggregate LOI for a group. In step 101, a group of at least one or more people can be identified. The group of people can be of any size, and may vary from being as small as a single person or a family, to larger groups such as a clan or tribe. Each of the persons in the group, 102A, 102B, . . . 102N, can be identified and the LOI score for each person can be determined at corresponding steps 103A, 103B, . . . 103N. After this step, the LOI scores for each person in the group can be aggregated at step 104. The aggregate LOI score may take the form of a sum, a product, an average, a median, or some other statistical or mathematical means of combining each of the LOI scores.

II. Determining the Influence Category for a Group

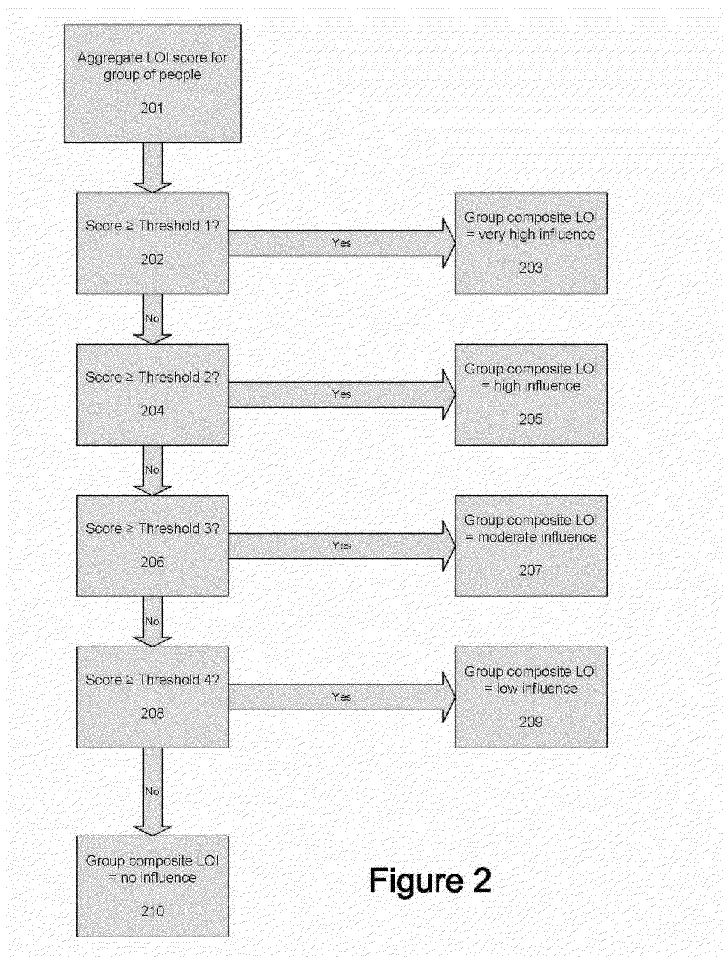

According to the disclosed embodiment, the aggregate LOI score may be used to determine a composite LOI for the group in terms of different categories of influence. FIG. 2 illustrates an exemplary procedure for determining the appropriate influence category. The aggregate LOI score for a group of people can be compared to a first score threshold in step, 202. If the score is greater than or equal to the threshold, the group can be deemed to have very high influence, 203. Otherwise, the step of comparing is repeated for a second, 204, third, 206, and fourth, 208, thresholds corresponding to high influence, 205, moderate influence, 207, and low influence, 209. If the aggregate LOI score is not greater than or equal to any thresholds, the group is determined to have no influence, 210. The influence categories are not limited to the five listed above, and any number of influence categories could be utilized.

III. Determining the LOI Score of a Person

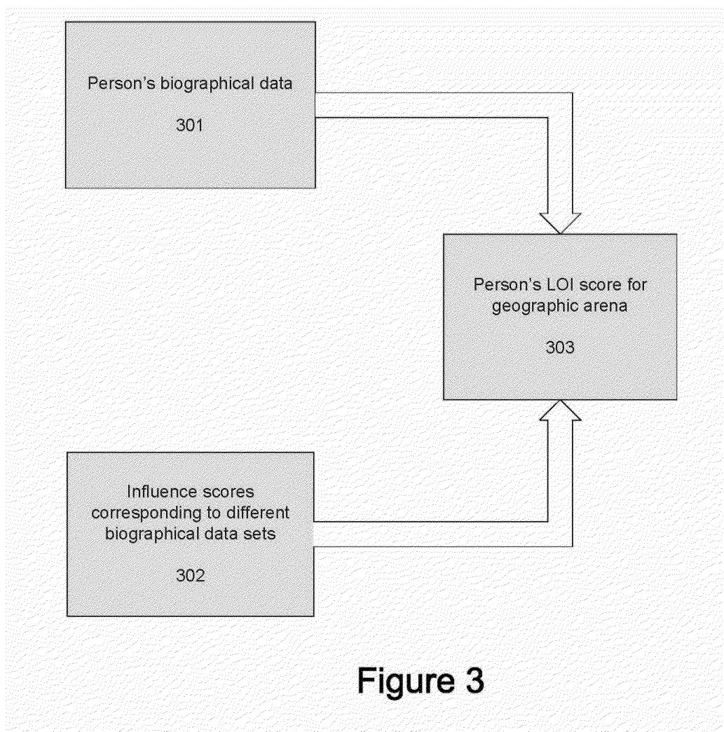

FIG. 3 shows a exemplary process for determining the LOI score of a person, corresponding to step 103 in FIG. 1. The person's biographical data, 301, is preferably compared to a set of influence scores corresponding to different possible sets of biographical data, 302, in order to determine a LOI score for the person in a geographic arena, 303.

Person's Biographical Data

The person's biographical data, 301, can include information related to occupation, occupational history, government affiliations, military affiliations, wealth, tribal affiliations, familial affiliations, education, religious convictions, religious affiliations, professional affiliations, military rank, police rank, political views, political affiliations, or any other biographical data. While the disclosed embodiments described the use of biographical data in this context, any other information relevant to the person may be considered when determining the person's LOI score.

Biographical data may be entered into the computing system through any suitable means, for example, manually by one or more users, imported from a storage, downloaded or received from one or more information sources, such as personnel or government databases, populated automatically and updated dynamically using online sources such as websites, blogs, news outlets, twitter feeds, and other electronic resources, and the like. An automatic web scraping program may also be used to search the web for any news or information concerning a particular person, and the system can be populated with any relevant information.

Influence Scores Corresponding to Different Possible Sets of Biographical Data

In order to accurately assess the LOI for an individual, their biographical data can be compared to different possible sets of biographical data which have corresponding LOI scores. The relationship between a particular set of biographical data and a certain LOI score can be determined either manually by a country or region specialist who is familiar with the geopolitical climate of the particular region, or by using a computerized process which can be customized for the particular region or country. The LOI may also be automatically correlated with various biographical factors such as wealth and education level.

Furthermore, a computer program may be used to automatically track any developments or news stories concerning a particular region or individuals and groups in the region, and update the corresponding influence scores depending on the calculated impact of the developments or events in the news story. For example, the portion of the LOI scores corresponding to the biographical data of belonging to a particular tribe, tribe A, may decrease if a prominent leader of tribe A is assassinated, or if tribe A loses ground to another tribe in a dispute. In another example, the portion of the LOI score corresponding to the biographical data of being affiliated with a certain political party may be affected if that political party gains more support in a recent election.

Influenced-Group Parameter

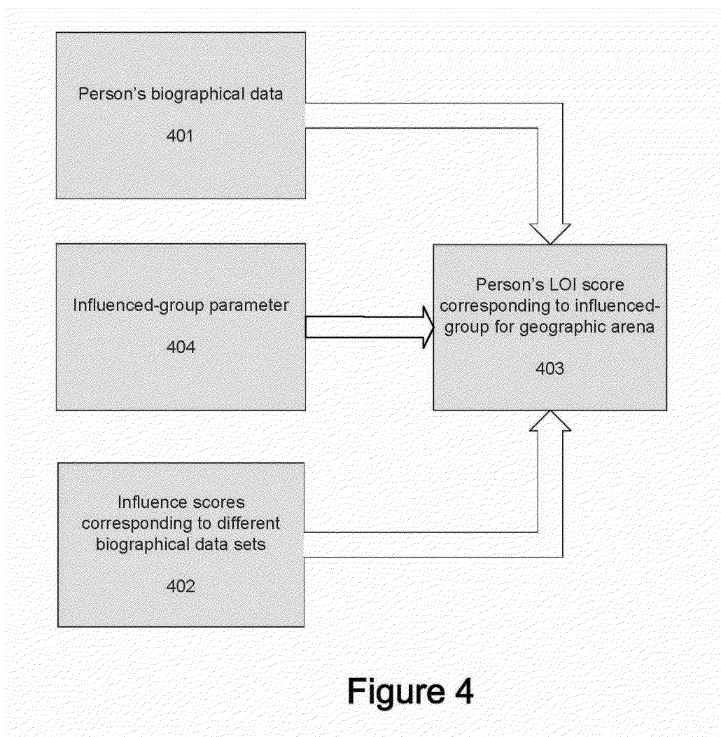

The LOI score for an individual may also be determined with respect to a particular group or type of group. FIG. 4 illustrates an exemplary embodiment which is similar in many respects to FIG. 3, but contains the additional feature of utilizing an influenced-group parameter, 404, in addition to a person's biographical data, 401, and influence scores corresponding to different biographical data sets, 402. This influenced-group parameter can represent the group or type of group that the LOI score is measured relative to. In other words, the influenced-group parameter can affect the LOI score, 403, to reflect how influential a person with a certain set of biographical data is with a certain group or type of group.

An exemplary influenced-group parameter comprises a family, a clan, or a tribe. These parameters would indicate how influential a person with a certain set of biographical data is for a family, a clan, and a tribe. So, for example, a person who is a high ranking political party member may have a higher LOI score if the influenced-group parameter is set to the tribe, and a lower LOI score if the influenced-group parameter is set to a family, since high ranking political party members conceivable have less influence over individual families than they do over larger groups.

Although the influenced-group parameter is discussed with reference to the three influenced-group parameters above, any number of parameters may be utilized to reflect the different possible groups of people influenced. For example, the influenced-group parameter could comprise a county parameter, a city parameter, a state parameter, and a nation parameter.

Geographic Arena and the Spatial Scale Parameter

In addition, a spatial scale parameter can also be utilized to affect the LOI score for a person based on the geographic arena over which the LOI is desired. In other words, the spatial scale parameter can be used to indicate how influential a person with a certain set of biographical data is for a geographic region which corresponds to a certain spatial scale.

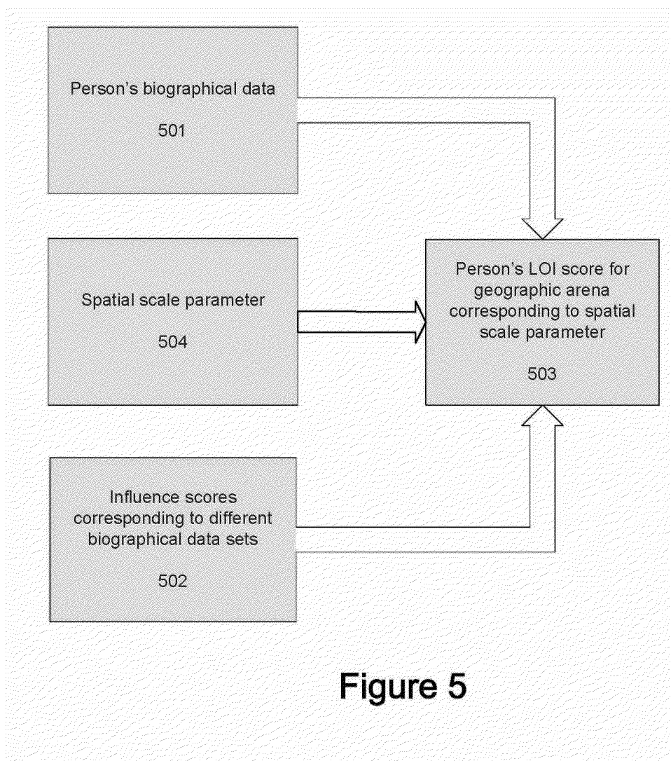

FIG. 5 illustrates the operation of such a parameter. Similar to other embodiments, the LOI score can be determined using a person's biographical data, 501, and influence scores corresponding to different biographical data sets, 502. In addition to these determinants, the LOI score is also affected by the spatial scale parameter, 504. The result is a measure of the LOI of a person with a particular set of biographical data in a geographic arena which corresponds to the spatial scale parameter, 503.

Exemplary spatial scale parameters may comprise a local scale, a provincial scale, or a national scale. Using this example, a person who is a small business owner may have a higher LOI score if the spatial scale parameter is set to the local scale than the national scale since their dealings occur primarily on the local scale. Similarly, a priest or cleric may have a much higher LOI score when the spatial scale parameter is set to the local scale since their congregation may not extend outside of their small community.

Although the spatial scale parameter is discussed with reference to the three spatial scale parameters above, any number of parameters may be utilized to reflect the different geographic areas over which influence is to be determined.

Spatial Scale Parameter in Conjunction with Influenced-Group Parameter

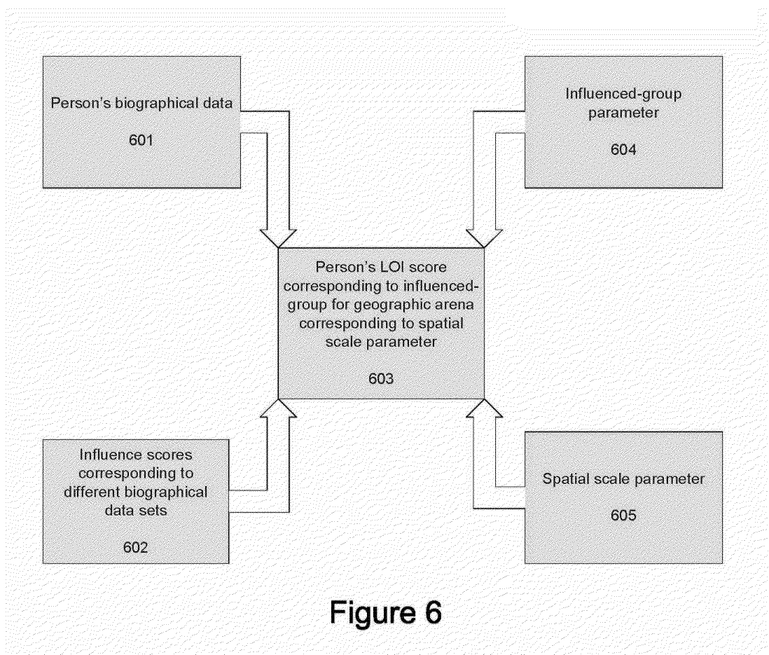

According to the disclosed embodiment, both the spatial scale parameter and the influenced group parameter may be used to determine a LOI score for an individual, as shown in FIG. 6. In this scenario, a person's biographical data, 601, influence scores corresponding to different biographical data sets, 602, influenced-group parameter, 604, and spatial scale parameter, 605, are used to determine the person's LOI score corresponding to an influenced-group for a geographic arena which corresponds to a spatial scale parameter, 603. For example, using the sample influenced-group parameters and spatial scale parameters discussed above, if the influenced-group parameter is set to family and the spatial scale parameter is set to national, the determination of a LOI score for a congressman would determine the LOI the congressman has on families at the national level.

Example of LOI Scores in Yemen

Table 1 below shows exemplary LOI scores corresponding to different sets of biographical data using the example of Yemen. For the purpose of the example, the influenced-group parameter is set to the clan or family levels, which in the example of Yemen, are identical.

TABLE 1
Exemplary LOI scores in Yemen reflecting influence on a clan or family

| Categories | Local | Provincial | National | Justification for given weight | Exceptions |
|---|---|---|---|---|---|
| Business Persons | 6 | 4 | 3 | Owners, employees, managers, and | (+3) to owners and |
| | | | | executives of all private sector | executives of major |
| | | | | organizations excluding non-profit | businesses |
| | | | | organizations. Excluding owners and | |
| | | | | executives of major industry, business | |
| | | | | persons, especially small business | |
| | | | | owners do not typically have much | |
| | | | | influence outside of their local area. | |
| Entertainers | 2 | 2 | 2 | Singers, dancers, musicians, actors, | (+2) to Nationally |
| | | | | TV/movie directors, and producers. | recognized, well known |
| | | | | Entertainers typically have little | entertainers |
| | | | | influence in the Middle East in general | |
| | | | | and Yemen in particular. | |
| Government | 7 | 5 | 4 | All levels of current/former government | (+3) for current/ |
| Officials | | | | employees from all departments and | ministers, |
| | | | | ministries excluding the legislative and | ambassadors, and |
| | | | | judicial branches and local government | deputy ministers |
| | | | | employees. Various positions encompass | |
| | | | | differing levels of influence depicted in | |
| | | | | the exceptions. | |
| Higher | 7 | 5 | 3 | Current/former college and university | (+3) for university |
| Education | | | | professors and all other faculty members | deans/presidents |
| Faculty/Staff | | | | of a higher education organization. | (+1) to other high level |
| | | | | University professors are generally | university officials (vice |
| | | | | respected in Yemeni culture and exert | president, assistant dean) |
| | | | | considerable influence locally. | |
| Legal/Judicial | 4 | 2 | 1 | Official Judges, lawyers, and | (+4 or +5) to supreme |
| Workers | | | | prosecutors. | court judges |
| Legislators | 9 | 8 | 6 | Current/former members of the House of | (+1) for leaders of |
| | | | | Representatives and current/former | parliamentary committees |
| | | | | members of the Shura Council. The | (+2) for House of |
| | | | | influence implied reflects the various | Representatives and |
| | | | | factors that help a candidate secure a seat | Shura Council |
| | | | | in the parliament (tribe, wealth, | speaker/chairman |
| | | | | education, career experience). | |
| Local | 7 | 4 | 2 | Local government officials are expected | (+3) to provincial |
| Government | | | | to be much more influential at the local | governors |
| Officials | | | | level. | (+2) to mayors of large |
| | | | | | cities |
| | | | | | (+1) to mayors of small |
| | | | | | towns and villages |
| Media/ | 1 | 3 | 6 | Journalists, columnists, newspaper and | (+4) for editors of major |
| Communications | | | | magazine editors, and news anchors. | newspapers |
| Personnel | | | | Media personnel exert some influence on | |
| | | | | a national level, and significantly less on | |
| | | | | a local scale. | |
| Military | 4 | 3 | 1 | Current/former members of the armed | (+6) commanders of the |
| Personnel | | | | services. The weights differ significantly | different branches of the |
| | | | | based on the individual's rank. | military |
| | | | | | (+5) for generals the |
| | | | | | military |
| NGO Personnel | 2 | 2 | 4 | Non-government organizations to include | |
| | | | | all non-profits, charitable organizations, | |
| | | | | educational and civic non-government | |
| | | | | organizations, etc. Little influence on | |
| | | | | Yemeni society locally. | |
| Police Officers | 5 | 3 | 1 | Current/former members of the police | (+5) for the chief of police |
| | | | | force. Influence is much more | (+3) for province/district |
| | | | | substantial locally with the exception | police chiefs |
| | | | | of police chiefs. | |
| Political Party | 2 | 3 | 5 | Current/former members and leaders of | (+1 or +4) for leadership |
| Members | | | | any political party who do not hold | positions contingent on |
| | | | | official positions with the government. | the size of the party |
| Professionals | 6 | 4 | 2 | Medical Doctors, Dentists, Engineers, | |
| | | | | and all other professions not included in | |
| | | | | any other category. On a national scale, | |
| | | | | the influence of professionals outside of | |
| | | | | their professional associations is minimal. | |
| | | | | However, professionals enjoy significant | |
| | | | | influence locally. | |
| Scholars | 7 | 4 | 2 | Religious scholars, writers, authors, & | (−1) to writers/authors |
| | | | | poets. Scholars are very influential | |
| | | | | locally, and religious scholars can be | |
| | | | | very significant on a local level | |
| | | | | especially within their respective sects. | |
| School System | 5 | 2 | 1 | Teachers of k-12, school system | (+1) for high level |
| Employees | | | | administrators and employees in general. | administrators |
| | | | | Minimal influence on a national level, | |
| | | | | but significantly influential at the local | |
| | | | | level. | |
| Tribal Figures | 8 | 5 | 3 | Prominent tribal figures other than | (+2) for tribal figures with |
| | | | | current tribal sheikhs. Tribal figures have | confederation level |
| | | | | considerable influence at the local level, | influence/recognition |
| | | | | and some influence at the provincial | |
| | | | | level, tribal figures are often involved in | |
| | | | | settling local political, financial, turf, and | |
| | | | | tribal conflicts in their area. | |

As shown in Table 1, LOI scores are listed for different categories of persons on three different spatial scales: local, provincial, and national. Each of the categories incorporates the different types of biographical data discussed above, such as occupation, occupational history, government affiliations, military affiliations, wealth, tribal affiliations, familial affiliations, education, religious affiliations, etc.

Table 1 further includes a modifiers column, which allows a greater degree of customization of the LOI score for certain figures who may possess unique characteristics relative to others in that category which allow them to exert more influence or limit their influence. For example, a regular low ranking soldier is considered military personnel and does not exert a large influence at a national level, resulting in a LOI score of 1, but a general would also be considered military personnel and understandably has a modifier of +5 to reflect the much higher than usual influence a general wields compared to other military personnel, resulting in a LOI score of 6 at the national level.

The data and LOI scores shown in Table 1 are only presented as an example of one way that LOI scores could be determined for a particular geographic region, and users could easily customize the biographical data used and scoring methodology to suit their own needs. Every country or region will have unique characteristics which affect the distribution of power and the resulting levels of influence for people. For example, in countries with totalitarian governments, military or political leaders may be considered to have a greater LOI than corresponding leaders in democratic countries, and this could be reflected in their LOI scores.

TABLE 2
Exemplary LOI scores in Yemen reflecting national influence on a tribe

| Categories | National | Justification for given weight | Exceptions |
|---|---|---|---|
| Government | 6 | All levels of current/former government employees | (+3) for current/ministers, |
| Officials | | from all departments and ministries excluding the | ambassadors, and deputy |
| | | legislative and judicial branches and local | ministers |
| | | government employees. Various positions encompass | |
| | | differing levels of influence depicted in the | |
| | | exceptions. | |
| Higher | 4 | Current/former college and university professors and | (+3) for university |
| Education | | all other faculty members of a higher education | deans/presidents |
| Faculty/Staff | | organization. University professors are generally | (+1) to other high level |
| | | respected in Yemeni culture and exert considerable | university officials (vice |
| | | influence locally. | president, assistant dean) |
| Legal/ | 4 | Official Judges, lawyers, and prosecutors. | (+4 or +5) to supreme court |
| Judicial | | | judges |
| Workers | | | |
| Legislators | 7 | Current/former members of the House of | (+1) for leaders of parliamentary |
| | | Representatives and current/former members of the | committees |
| | | Shura Council. The influence implied reflects the | (+2) for House of Representative |
| | | various factors that help a candidate secure a seat in | and Shura Council |
| | | the parliament (tribe, wealth, education, career | speaker/chairman |
| | | experience). | |
| Local | 2 | Local government officials are expected to be much | (+3) to provincial governors |
| Government | | more influential at the local level. | (+2) to mayors of large cities |
| Officials | | | (+1) to mayors of small towns |
| | | | and villages |
| Military | 5 | Current/former members of the armed services. The | (+6) commanders of the different |
| Personnel | | weights differ significantly based on the individual's | branches of the military |
| | | rank. | (+5) for generals the military |
| Police | 5 | Current/former members of the police force. | (+5) for the chief of police |
| Officers | | Influence is much more substantial locally with | (+3) for province/district police |
| | | the exception of police chiefs. | chiefs |
| Political Party | 3 | Current/former members and leaders of any political | (+1 or +4) for leadership |
| Members | | party who do not hold official positions with the | positions contingent on the size |
| | | government. | of the party |
| Scholars | 4 | Religious scholars, writers, authors, & poets. Scholars | (−1) to writers/authors |
| | | are very influential locally, and religious scholars can | |
| | | be very significant on a local level especially within | |
| | | their respective sects. | |
| Tribal Figures | 4 | Prominent tribal figures other than current tribal | (+2) for tribal figures with |
| | | sheikhs. Tribal figures have considerable influence at | confederation level |
| | | the local level, and some influence at the provincial | influence/recognition |
| | | level, tribal figures are often involved in settling local | |
| | | political, financial, turf, and tribal conflicts in their | |
| | | area. | |

Table 2 shows exemplary LOI scores at a national level for the influence of a person on a tribe in Yemen. As is evident from Table 1 and Table 2, the LOI scores for a person with a certain set of biographical data can vary even for the same spatial scale parameter, due to changes in the influenced-group parameter. For example, a government official has an LOI score of 6 in Table 2, reflecting the official's influence on tribe at a national level. By contrast, the government official has an LOI score of only 4 at the national level in Table 1, reflecting the official's influence on families and clans at a national level.

Exceptions to Group Influence Category Determination

In some embodiments, exceptions to the normal group aggregate LOI score calculation and influence category determination rules may be put into place for groups that have members with very high levels of influence that disproportionately affect the influence of the group. For example, in the case of Yemen, tribes with members who are the current president, former president, current vice president, current prime minister, current speaker/chairman of the House of Representatives or Shura Council, current army chief of staff, or current director of general intelligence or other national security apparatus, and the like, can automatically be considered to have very high influence. Similarly tribes with members who are the current minister, a Shura Council member, or general secretary of the ruling political party, and the like can be considered to have high influence.

IV. Computing Environment

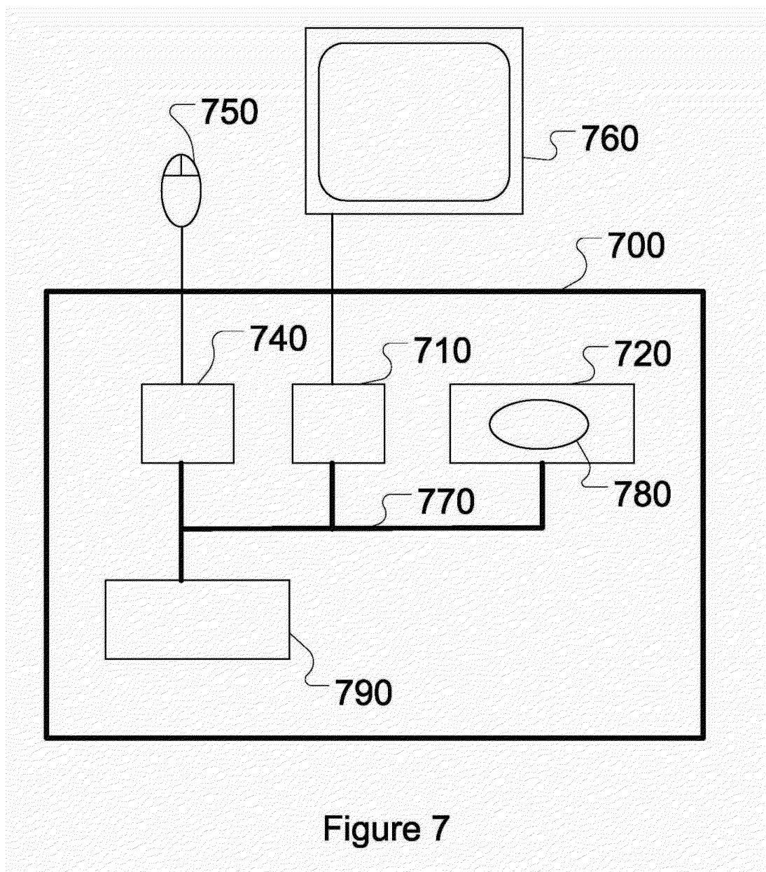

One or more of the above-described techniques can be implemented in or involve one or more computer systems. FIG. 7 illustrates a generalized example of a computing environment 700. The computing environment 700 is not intended to suggest any limitation as to scope of use or functionality of described embodiments.

With reference to FIG. 7, the computing environment 700 includes at least one processing unit 710 and memory 720. The processing unit 710 executes computer-executable instructions and may be a real or a virtual processor. In a multi-processing system, multiple processing units execute computer-executable instructions to increase processing power. The memory 720 may be volatile memory (e.g., registers, cache, RAM), non-volatile memory (e.g., ROM, EEPROM, flash memory, etc.), or some combination of the two. In some embodiments, the memory 720 stores software 780 implementing described techniques.

A computing environment may have additional features. For example, the computing environment 700 includes storage 740, one or more input devices 750, one or more output devices 760, and one or more communication connections 790. An interconnection mechanism 770, such as a bus, controller, or network interconnects the components of the computing environment 700. Typically, operating system software (not shown) provides an operating environment for other software executing in the computing environment 700, and coordinates activities of the components of the computing environment 700.

The storage 740 may be removable or non-removable, and includes magnetic disks, magnetic tapes or cassettes, CD-ROMs, CD-RWs, DVDs, or any other medium which can be used to store information and which can be accessed within the computing environment 700. In some embodiments, the storage 740 stores instructions for the software 780.

The input device(s) 750 may be a touch input device such as a keyboard, mouse, pen, trackball, touch screen, or game controller, a voice input device, a scanning device, a digital camera, or another device that provides input to the computing environment 700. The output device(s) 760 may be a display, printer, speaker, or another device that provides output from the computing environment 700.

The communication connection(s) 790 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 700, computer-readable media include memory 720, storage 740, communication media, and combinations of any of the above.

Of course, FIG. 7 illustrates computing environment 700, display device 760, and input device 750 as separate devices for ease of identification only. Computing environment 700, display device 760, and input device 750 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 700 may be one or more servers, for example a farm of networked servers, a clustered server environment, or a cloud network of computing devices.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A computer-implemented method executed by one or more computing devices for determining the level of influence of a group of persons, comprising:
determining, by at least one of the one or more computing devices, a level of influence score for at least one member of a group of persons based on biographical data corresponding to the at least one member of the group of persons;
aggregating, by at least one of the one or more computing devices, the level of influence scores for the at least one member of the group of persons; and
determining, by at least one of the one or more computing devices, a composite level of influence for the group of persons based on the aggregate level of influence score.

2. The computer implemented method of claim 1, wherein the biographical data comprises at least one of:
occupation, occupational history, government affiliations, military affiliations, wealth, tribal affiliations, familial affiliations, education, religious convictions, religious affiliations, professional affiliations, military rank, police rank, political views, or political affiliations.

3. The computer implemented method of claim 1, wherein the level of influence score for the at least one member of the group of persons comprises:
a numerical value representative of the influence an individual with the corresponding biographical data exerts in a geographic arena.

4. The computer implemented method of claim 1, wherein determining the level of influence score for at the least one member of the group of persons further comprises:
utilizing an influenced-group parameter in conjunction with the biographical data corresponding to the at least one member of the group of persons to determine the level of influence score.

5. The computer implemented method of claim 4, wherein the influenced group parameter comprises at least one of a family, a clan, and a tribe.

6. The computer implemented method of claim 4, wherein the level of influence score for the at least one member of the group of persons comprises:
a numerical value representative of the influence an individual with the corresponding biographical data exerts on groups corresponding to the influenced-group parameter in a geographic arena.

7. The computer implemented method of claim 1, wherein determining the level of influence score for at the least one member of the group of persons further comprises:
utilizing a spatial scale parameter in conjunction with the biographical data corresponding to the at least one member of the group of persons to determine the level of influence score.

8. The computer implemented method of claim 7, wherein the spatial scale parameter comprises at least one of a local scale, a provincial scale, and a national scale.

9. The computer implemented method of claim 7, wherein the level of influence score for the at least one member of the group of persons comprises:
a numerical value representative of the influence an individual with the corresponding biographical data exerts in a geographic arena corresponding to the spatial scale parameter.

10. The computer implemented method of claim 1, wherein determining a composite level of influence for the group comprises:
comparing, by at least one of the one or more computing devices, the aggregate level of influence score with a plurality of score thresholds corresponding to a plurality of influence categories;
if the aggregate level of influence score is greater than or equal to at least one score threshold, setting, by at least one of the one or more computing devices, the composite level of influence of the group to be the influence category corresponding to the highest score threshold that the aggregate level of influence score is greater than or equal to; and
otherwise, setting the composite level of influence of the group to a default value.

11. An apparatus for determining the level of influence of a group of persons, the apparatus comprising:
one or more processors; and
one or more memories operatively coupled to at least one of the one or more processors and having instructions stored thereon that, when executed by at least one of the one or more processors, cause at least one of the one or more processors to:
determine a level of influence score for at least one member of a group of persons based on biographical data corresponding to the at least one member of the group of persons;
aggregate the level of influence scores for the at least one member of the group of persons; and
determine a composite level of influence for the group of persons based on the aggregate level of influence score.

12. The apparatus of claim 11, wherein the biographical data comprises at least one of:
occupation, occupational history, government affiliations, military affiliations, wealth, tribal affiliations, familial affiliations, education, religious convictions, religious affiliations, professional affiliations, military rank, police rank, political views, or political affiliations.

13. The apparatus of claim 11, wherein the level of influence score for the at least one member of the group of persons comprises:
a numerical value representative of the influence an individual with the corresponding biographical data exerts in a geographic arena.

14. The apparatus of claim 11, wherein the instructions that cause at least one of the one or more processors to determine the level of influence score for at the least one member of the group of persons further cause at least one of the one or more processors to utilize an influenced-group parameter in conjunction with the biographical data corresponding to the at least one member of the group of persons to determine the level of influence score.

15. The apparatus of claim 14, wherein the influenced group parameter comprises at least one of a family, a clan, and a tribe.

16. The apparatus of claim 14, wherein the level of influence score for the at least one member of the group of persons comprises:
a numerical value representative of the influence an individual with the corresponding biographical data exerts on groups corresponding to the influenced-group parameter in a geographic arena.

17. The apparatus of claim 11, wherein the instructions that cause at least one of the one or more processors to determine the level of influence score for at the least one member of the group of persons further cause at least one of the one or more processors to utilize a spatial scale parameter in conjunction with the biographical data corresponding to the at least one member of the group of persons to determine the level of influence score.

18. The apparatus of claim 17, wherein the spatial scale parameter comprises at least one of a local scale, a provincial scale, and a national scale.

19. The apparatus of claim 17, wherein the level of influence score for the at least one member of the group of persons comprises:
a numerical value representative of the influence an individual with the corresponding biographical data exerts in a geographic arena corresponding to the spatial scale parameter.

20. The apparatus of claim 11, wherein the instructions that cause at least one of the one or more processors to determine a composite level of influence for the group further cause at least one of the one or more processors to:
compare the aggregate level of influence score with a plurality of score thresholds corresponding to a plurality of influence categories;
if the aggregate level of influence score is greater than or equal to at least one score threshold, set the composite level of influence of the group to be the influence category corresponding to the highest score threshold that the aggregate level of influence score is greater than or equal to; and
otherwise, set the composite level of influence of the group to a default value.

21. At least one non-transitory computer-readable medium storing computer-readable instructions that, when executed by one or more computing devices, cause at least one of the one or more computing devices to:
determine a level of influence score for at least one member of a group of persons based on biographical data corresponding to the at least one member of the group of persons;
aggregate the level of influence scores for the at least one member of the group of persons; and
determine a composite level of influence for the group of persons based on the aggregate level of influence score.

22. The at least one non-transitory computer-readable medium of claim 21, wherein the biographical data comprises at least one of:
occupation, occupational history, government affiliations, military affiliations, wealth, tribal affiliations, familial affiliations, education, religious convictions, religious affiliations, professional affiliations, military rank, police rank, political views, or political affiliations.

23. The at least one non-transitory computer-readable medium of claim 21, wherein the level of influence score for the at least one member of the group of persons comprises:
a numerical value representative of the influence an individual with the corresponding biographical data exerts in a geographic arena.

24. The at least one non-transitory computer-readable medium of claim 21, wherein the instructions that cause at least one of the one or more computing devices to determine the level of influence score for at the least one member of the group of persons further cause at least one of the one or more computing devices to utilize an influenced-group parameter in conjunction with the biographical data corresponding to the at least one member of the group of persons to determine the level of influence score.

25. The at least one non-transitory computer-readable medium of claim 24, wherein the influenced group parameter comprises at least one of a family, a clan, and a tribe.

26. The at least one non-transitory computer-readable medium of claim 24, wherein the level of influence score for the at least one member of the group of persons comprises:
a numerical value representative of the influence an individual with the corresponding biographical data exerts on groups corresponding to the influenced-group parameter in a geographic arena.

27. The at least one non-transitory computer-readable medium of claim 21, wherein the instructions that cause at least one of the one or more computing devices to determine the level of influence score for at the least one member of the group of persons further cause at least one of the one or more computing devices to utilize a spatial scale parameter in conjunction with the biographical data corresponding to the at least one member of the group of persons to determine the level of influence score.

28. The at least one non-transitory computer-readable medium of claim 27, wherein the spatial scale parameter comprises at least one of a local scale, a provincial scale, and a national scale.

29. The at least one non-transitory computer-readable medium of claim 27, wherein the level of influence score for the at least one member of the group of persons comprises:
a numerical value representative of the influence an individual with the corresponding biographical data exerts in a geographic arena corresponding to the spatial scale parameter.

30. The at least one non-transitory computer-readable medium of claim 21, wherein the instructions that cause at least one of the one or more computing devices to determine a composite level of influence for the group further cause at least one of the one or more computing devices to:
compare the aggregate level of influence score with a plurality of score thresholds corresponding to a plurality of influence categories;
if the aggregate level of influence score is greater than or equal to at least one score threshold, set the level of influence of the group to be the influence category corresponding to the highest score threshold that the aggregate level of influence score is greater than or equal to; and
otherwise, set the composite level of influence of the group to a default value.
